(19) United States
(12) Patent Application Publication
(10) Pub. No.: US 2006/0284595 A1
(43) Pub. Date: Dec. 21, 2006

(54) CHARGING MODE CONTROL CIRCUIT AND METHOD

(76) Inventors: Kuan-Hong Hsieh, Shenzhen (CN); Han-Che Wang, Shenzhen (CN); Shin-Hong Chung, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,005

(22) Filed: Jun. 7, 2006

(30) Foreign Application Priority Data
Jun. 17, 2005 (CN) 200510035396.4

(51) Int. Cl. H02J 7/00

(52) U.S. Cl. 320/115

(57) ABSTRACT

The present invention provides a charging mode control circuit and method. By utilizing such charging mode control circuit and method, a secondary battery fixed in a portable device can be quickly charged when the portable device communicate with an external computer. The method includes the steps of:a) providing a commutator, the commutator comprising an AC/DC adapter, a first interface, and a second interface, wherein the first interface is connected to the external computer and the second interface is connected to the portable device; b) comparing a charging voltage with a reference voltage, thereby producing a high voltage level signal according to a comparison result, wherein the charging voltage come from the AC/DC adapter; and c) selecting a fast-charging mode on the secondary battery according to the high voltage level signal.

### TECHNICAL FIELD

The present invention relates to a charging mode control circuit and method, particularly to a charging mode control circuit and method used in a portable device.

### GENERAL BACKGROUND

Portable devices with Universal Serial Bus (USB) interfaces such as portable computers are welcomed by users for their small size and convenient usage. At present there are generally two solutions for charging a secondary battery equipped in a portable device.

One of the solution is shown in FIG.1 where a portable device 11 is connected with a computer 12 via their USB interfaces (i.e., USB interface 113 and USB interface 121). According to the protocol standards of USB 1.1 and USB 2.0, the maximum power transmitted by USB interfaces is 2.5 watt (0.5A @ 5V), in other words, the computer supplies no more than 500 mA charging current under the charging voltage of +5V. Given these circumstances, a secondary battery 11 fixed within the portable device 11 can obtain a charging current from the computer 12 while in-link with the computer, however this charging current is rather small and the charging speed is rather slow.

Another solution is shown in FIG. 2, a portable device 21 is connected to a mains supply 24 via an alternating current to direct current converter (AC/DC) adapter 22. The portable device 21 and the AC/DC adapter 22 both have a USB interface (i.e., USB interface 213 and USB interface 221) for inter-connecting each other. A secondary battery 211 fixed within the portable device 21 obtains a charging current from a mains supply 24 after the AC/DC adapter 22 performs a voltage transformation. Using such charging means, a secondary battery 211 fixed within the portable device 21 can obtain a fairly bigger current resulting to a quicker charging speed, however, the portable device will not be able to communicate with a computer while the battery 211 is charging.

Accordingly, it would be advantageous if the secondary battery fixed in the portable device can obtain the charging current with a fairly faster speed without terminating any data transmission between the computer and the portable device.

### SUMMARY

A charging mode control method is provided. The method is for charging a secondary battery fixed in a portable device during the same time period of data communication with an external computer. The method includes the steps of:a) providing a commutator, the commutator comprising an adapter, a first interface, and a second interface, wherein the first interface is connected to the external computer and the second interface is connected to the portable device; b) comparing a charging voltage with a reference voltage, thereby producing a high voltage level signal according to a comparison result, wherein the charging voltage come from the AC/DC adapter; and c) selecting a fast-charging mode on the secondary battery according to the high voltage level signal.

Another charging mode control method is provided. The method is for charging a secondary battery fixed in a portable device during the same time period of data communication with an external computer. The method includes the steps of: a) connecting the portable to the external computer with their own USB interfaces; b) comparing a charging voltage with a reference voltage, thereby producing a low voltage level signal according to a comparison result, wherein the charging voltage come from the external computer; and c) selecting a slow-charging mode on the secondary battery according to the low voltage level signal.

A portable device can communicate with an external computer and obtain a charging voltage from a charging power supply is further provided. The portable device includes: a voltage comparing circuit having two inputs that receive a charging voltage and a reference voltage respectively, and an output which sends out a voltage signal according to the comparison result of the charging voltage and the reference voltage; and a charging control circuit for selecting a corresponding charging mode on the secondary battery according to the voltage signal from the voltage comparing circuit. The charging control circuit has two inputs of which one of the inputs receives the voltage signal sent out by the output of the voltage comparing circuit and the other input receives the charging voltage and an output transmits a selective charging current to the secondary battery according to the selected charging mode.

A commutator for connecting a portable device and a computer is provided. The commutator includes an adapter for obtaining a charging voltage from a mains supply, the AC/DC adapter having a VCC (power) line and a GND (Ground) line; a first interface for connecting an external computer and transmitting data from the external computer, the first interface having a VCC pin, a GND pin, and a plurality of data pins; and a second interface for connecting the adapter and the portable device, the second interface having a VCC pin, a GND pin, and a plurality of data pins; wherein the GND pin and the data pins of the second interface respectively connect to the GND pin and the data pins of the first interface, and the GND pin and the VCC pin of the second interface further connect to the GND line and the VCC line of the adapter respectively .

Based on the present invention, the secondary battery can be charged in a fast-charging mode by inserting the commutator which include the AC/DC adapter therein between the computer and the portable device. The AC/DC adapter provides a relative large current for the charging mode control circuit, which make it feasible to charge the secondary battery fixed within the portable device quickly during data transmission with an external computer.

### BRIEF DESCRIPTION OF DRAWINGS

FIG. 1 is a block diagram of an exemplary application of prior charging means;

FIG. 2 is a block diagram of another exemplary application of prior charging means;

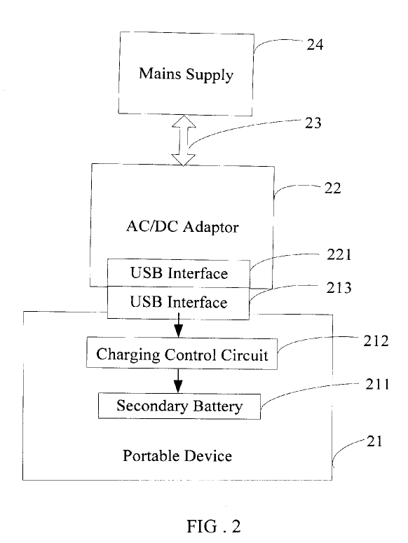

FIG. 3 is a block diagram of an exemplary application of charging mode control circuit and method in accordance with a preferred embodiment of the present invention; and

FIG. 4 depicts details of an exemplary charging mode control circuit.

### DETAILED DESCRIPTION

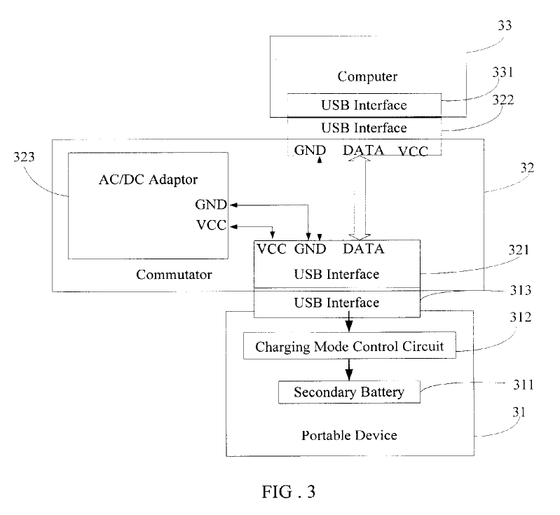

FIG. 3 is a block diagram of an exemplary application of a charging mode control circuit and method in accordance with a preferred embodiment of the present invention. Shown here are a portable device 31, a commutator 32, and a computer 33. The portable device 31 has a charging mode control circuit 312 incorporated therein and a secondary battery 311 fixed therein. The charging mode control circuit 312 is used to select a selective charging mode on the secondary battery 311 according to a particular charging power supply available.

The commutator 32 includes an adapter 323 and two USB interfaces 321 and 322. The USB interface 321 is connected directly to the USB interface 313 of the portable device 31 and the USB interface 322 is connected directly to the USB interface 322 of the computer 33. Each of the USB interfaces 321 and 322 has a VCC (power) pin, a GND (ground) pin, and a plurality of DATA (data) pins. The AC/DC adapter 323 has a VCC line and a GND line. The VCC pin and the GND pin of the USB interface 321 are respectively connected to the VCC line and the GND line of the AC/DC adapter 323, thereby obtaining a charging power supply from an external power supply (not shown) via the AC/DC adapter 323. Furthermore, the GND pin and DATA pins of the USB interface 321 are respectively connected to the GND pin and DATA pins of the USB interface 322, thereby communicating with the computer 33 when the USB interface 322 is connected to a USB interface 331 of the computer 33. The VCC pin of the USB interface 322 is kept idle.

Thus, by utilizing such connections, the portable device 30 not only can quickly obtain the charging power supply with a fairly greater current (larger than 500 mA) from the external mains supply, but can also perform data communication with the computer 33. During this charging process, the charging mode control circuit 312 chooses a rapid charging mode on the secondary battery 311.

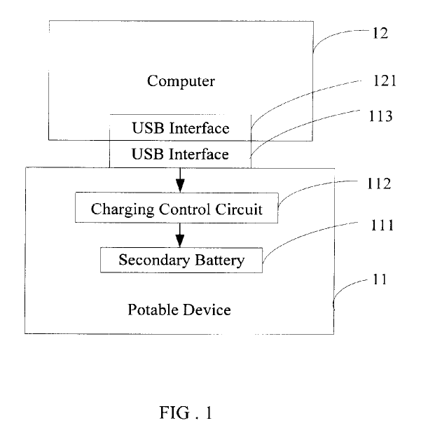

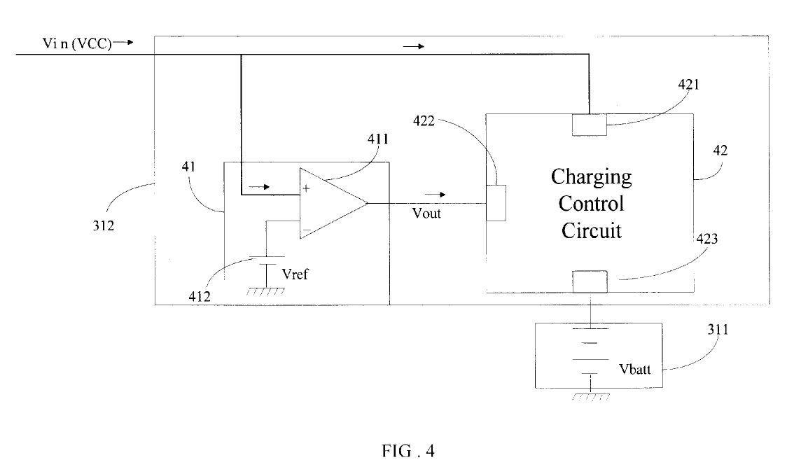

FIG. 3 shows the charging mode of the secondary battery 311 obtaining a large charging current (referred to as “a fast-charging mode”). If the portable device 11 is associated with the computer 12 via their own USB interfaces (i.e., USB interface 313 and USB interface 331) similar to FIG. 1, the secondary battery 311 obtains a small charging current (referred to as “a slow-charging mode”;) similar to FIG. 1 too. The two charging modes both support data communication between the portable device 31 and the computer 33 while the secondary battery 311 is charging. The schematic diagram of the charging mode control circuit 312 selecting a selective charging mode on the secondary battery 311 is depicted in detail in FIG. 4.

FIG. 4 depicts details of an exemplary charging mode control circuit namely, a charging mode control circuit 312 and a secondary battery 311. The charging mode control circuit 312 mainly includes a voltage comparator 41 and a charging control circuit 42.

The voltage comparing circuit 41 has a voltage comparator 411 and a reference voltage supply 412. The voltage comparator 41 compares a voltage Vin(VCC) conducted by the VCC pin of the USB interface 313 from an external power supply (e.g., a computer or a mains supply) with a reference voltage Vref provided by a reference power supply 412 thereof, and then produces a selective voltage level signal (e.g. high voltage level signal or low voltage level signal) to the charging control circuit 42.

The reference voltage Vref 312 can be set according to the charging voltages of the charging power supplies, that is, the reference voltage is within the range of the voltages provided by the charging power supplies. For example, supposing the charging power supplies are the mains supply and the computer, furthermore the voltage Vin(VCC) provided by the mains supply via the AC/DC adapter 323 is 6V and the voltage Vin(VCC) provided by the computer 33 is 5V, for simplicity, the reference voltage Vref would be set to 5.5V.

The charging control circuit 42 identifies the charging power supply according to the received voltage level signal from the voltage comparator 41, and selects a selective charging mode on charging the secondary battery 311. The charging control circuit 42 further has two inputs (symbolically expressed as 421 and 422) and an output (symbolically expressed as 423). The input 421 receives the voltage Vin(VCC) from the VCC pin of the USB interface 313. The input 422 receives the voltage level signal from the output of the voltage comparator 411. The output 423 is used to output the selective charging current for the secondary battery 311.

For example, if the voltage level signal is a low voltage level signal, the charging control circuit 42 selects a slow-charging mode on the secondary battery 311 with relative small charging current between 0 mA to 500 mA; if the voltage level signal is the high voltage level signal, the charging control circuit 42 selects a fast-charging mode on the secondary battery 311 with a relative large charging current between 0 mA to 1000 mA.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charging mode control method for charging a secondary battery fixed in a portable device at the same time of data communication with an external computer, the method comprising the steps of:
providing a commutator, the commutator comprising an adapter providing a charging voltage, a first interface and a second interface, wherein the first interface is connected to the external computer and the second interface is connected to the portable device;
comparing a charging voltage with a reference voltage, thereby producing a high voltage level signal according to a comparison result, wherein the charging voltage is provided by the adapter; and
selecting a fast-charging mode on the secondary battery according to the high voltage level signal.

2. A charging mode control method for charging a secondary battery fixed in a portable device at the same time of data communication with an external computer, the method comprising the steps of:
connecting the portable device to the external computer with USB interfaces;
comparing a charging voltage with a reference voltage, thereby producing a low voltage level signal according to a comparison result, wherein the charging voltage is provided by the external computer; and
selecting a slow-charging mode on the secondary battery according to the low voltage level signal.

3. A portable device communicating with an external computer and obtaining a charging voltage from a charging power supply, the portable device comprising a charging mode control circuit for selecting a charging mode on a secondary battery according to a voltage signal, the charging mode control circuit comprising:
a voltage comparing circuit having two inputs and an output, wherein:
one of the two inputs receive a charging voltage and the other of the two inputs receive a reference voltage; and
the output of the voltage comparing circuit sends out a voltage signal according to a comparison result of the charging voltage and the reference voltage; and
a charging control circuit for selecting a corresponding charging mode on the secondary battery according to the voltage signal provided by the voltage comparing circuit, the charging control circuit having two inputs and an output,
wherein:
one of the inputs of the charging control circuit receives the voltage signal from the output of the voltage comparing circuit;
the other input of the charging control circuit receives the charging voltage; and
the output of the charging control circuit transmits a selective charging current to the secondary battery according to the selected charging mode.

4. The portable device according to claim 3, wherein the charging voltage is selected from the group consisting of a voltage provided by an adapter and a voltage provided by an external computer.

5. The portable device according to claim 3, wherein the voltage signal is selected from the group consisting of a low voltage level signal and a high voltage level signal.

6. The portable device according to claim 3, wherein the charging control circuit selects a slow-charging mode if the voltage signal is the low voltage level signal, and selects a fast-charging mode if the voltage signal is the high voltage level signal.

7. The portable device according to claim 6, the range of the charging current is determined by the selected charging mode.

8. The portable device according to claim 7, the charging current is in a range between 0 mA and 500 mA in the slow-charging mode, and the charging current is in a range between 0 mA and 1000 mA in the fast-charging mode.

9. A commutator for connecting a portable device and a computer, by which a secondary battery fixed in the portable device is charged at the same time of communicating with the computer, the commutator comprising:
an adapter for obtaining a charging voltage from a mains supply, the adapter having a VCC line and a GND line;
a first interface for connecting an external computer and obtaining data from the external computer, the first interface having a VCC pin, a GND pin, and a plurality of DATA pins; and
a second interface for connecting the adapter and the portable device, the second interface having a VCC pin, a GND pin, and a plurality of DATA pins; wherein the GND pin and the DATA pins of the second interface are respectively connected to the GND pin and the DATA pins of the first interface, and the GND pin and the VCC pin of the second interface are further respectively connected to the GND line and the VCC line of the adapter.

10. The commutator according to claim 9, wherein the VCC pin of the first interface is kept idle.

11. The commutator according to claim 9, wherein the first interface and the second interface are USB interfaces.
